(19) United States
(12) Patent Application Publication
(10) Pub. No.: US 2021/0252955 A1
(43) Pub. Date: Aug. 19, 2021

(54) Automobile Drape

(71) Applicant: Richard John Anaya, Calabasas, CA (US)

(72) Inventor: Richard John Anaya, Calabasas, CA (US)

(21) Appl. No.: 16/791,915

(22) Filed: Feb. 14, 2020

(51) Int. Cl. B60J 11/06

(52) U.S. Cl. CPC B60J 11/06

(57) ABSTRACT

An automobile drape, that forms a changing space inside the drape.

### BACKGROUND

The inside space of an automobile is configured for sitting. It is very difficult to change one's clothing in such space. However, there are many instances when it is convenient to change clothes in your automobile.

### SUMMARY

The invention describes a special drape that can be used in conjunction with a vehicle to form a changing space outside the vehicle that is shielded from public view. The present application describes a special car mountable drape, which is intended to mount between doors and/or the body of an automobile using attachment mechanisms such as suction cups. This forms a changing space in between the two doors of the automobile, which is shielded from view. This allows users to change clothing much more comfortably and conveniently.

An embodiment describes the special drape, formed with grommet holes and suction cups with hooks that attaches to the door of an automobile, in a way that forms an enclosed special changing area supported by the frame of the automobile.

### BRIEF DESCRIPTION OF THE DRAWINGS

The different figures show different embodiments.

FIG. 1 shows the drape With its holes, and shows a set of suction cups with hooks that connect into the holes in the trade;

FIG. 2 shows a close up of how the suction cups hook into the drape and attach onto a car window;

FIGS. 3A, 3B and 3C show connecting the suction cups two different parts of an automobile to form the changing area with both car doors open; and

FIGS. 4A, 4B and 4C show configuring the changing space with one car door open.

### DETAILED DESCRIPTION

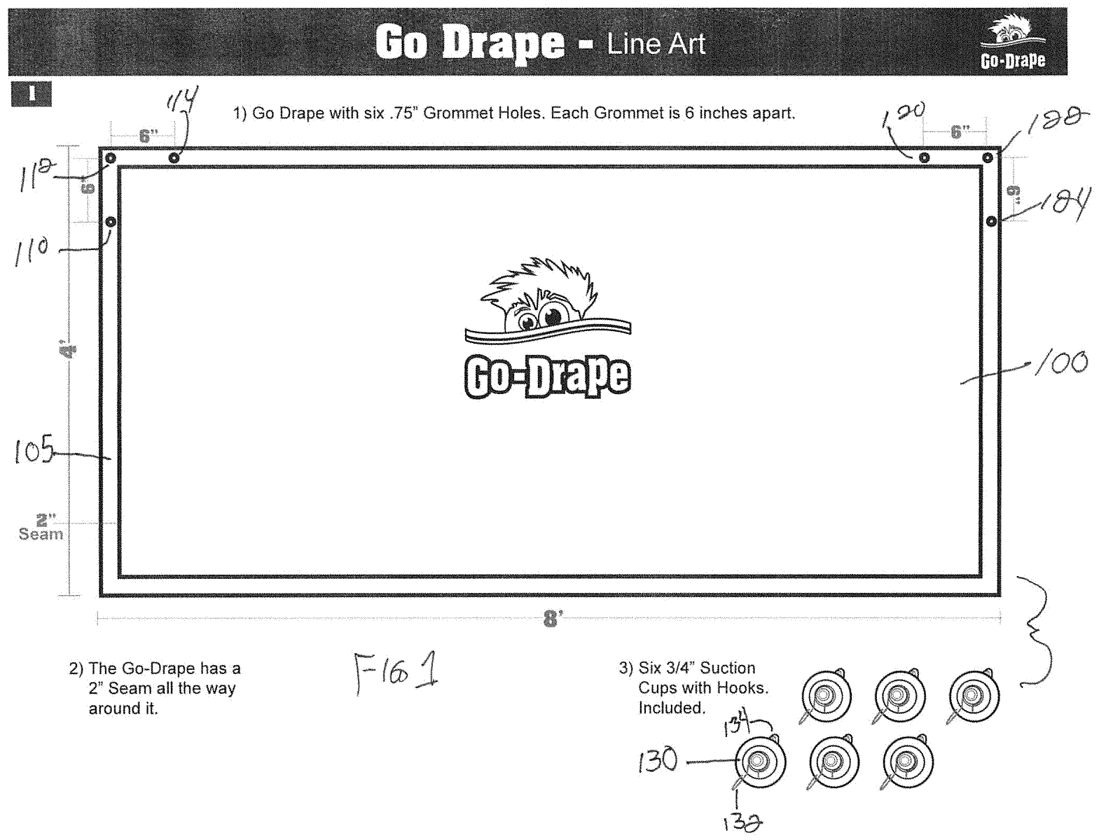

FIG. 1 illustrates the actual drape of the present application, and the remaining figures illustrate how the drape is attached to an automobile to form a changing area defined by the doors of the automobile. The drape 100 is formed of plastic or cloth material, preferably opaque so that it blocks viewing the inside of the changing area defined by the drape being attached to parts of a car. In this embodiment, the drape is 4 feet in height by 8 feet in length, enabling it to fit on almost any automobile. The drape material itself is surrounded by a 2 inch seam 105 which forms a reinforcing section on the plastic or cloth. The seam 105 includes grommet holes at the top, and on sides. These include the first grommet hole sections 110, 112, 114 holding the first side of the drape, and the second side grommet holes including 120, 122 and 124 holding the second side of the grommet holes. The grommet holes are sized to receive suction cups with hooks shown as 130, where each suction cup includes a suction portion, a hook portion 132, and a removal tab 134.

In operation, FIG. 2 illustrates how the hooks such as 132 are attached into the grommet holes such as 120 of the go drape 100. The suction cups 130 are then attached to a window or other structural section of the vehicle.

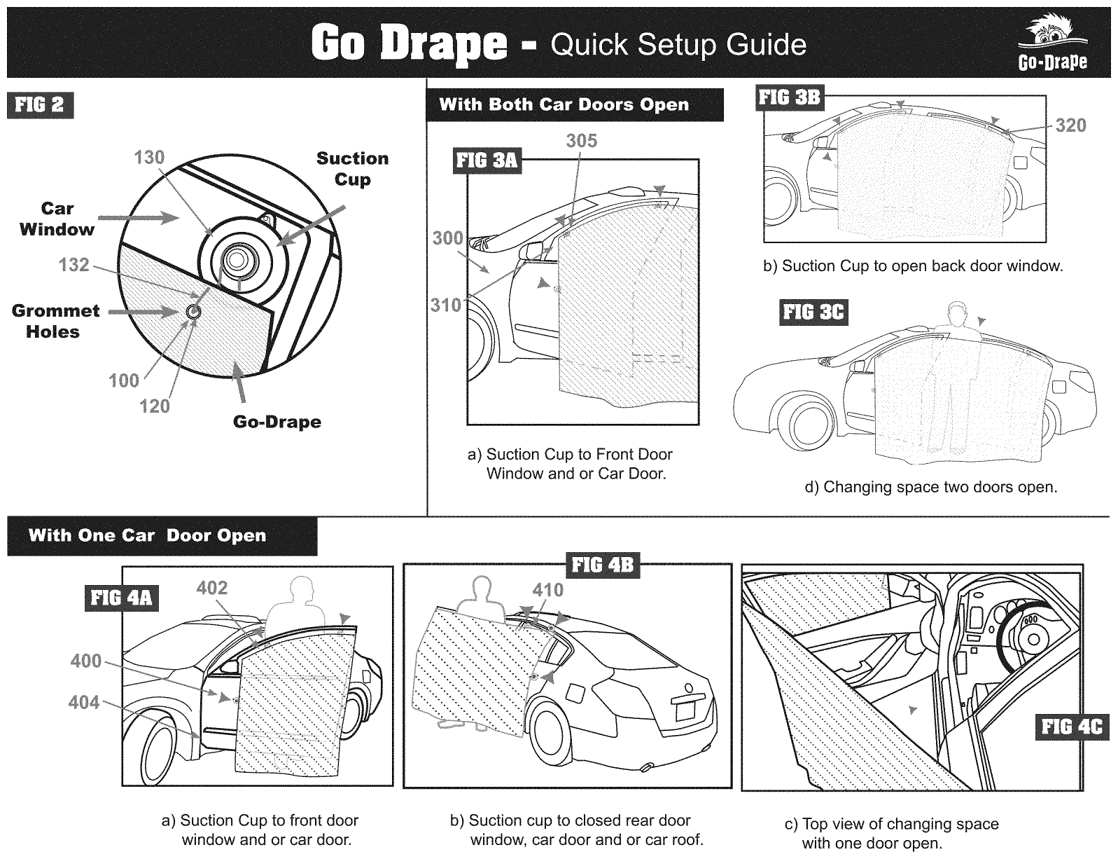

FIG. 3 illustrates how to attach the drape according to an embodiment. The drape is attached to one or both car doors of the vehicle 300. The user attaches one or more of the suction cups at the front portion 310 of the front window on the car door. All three of the suction cups can be attached at the area 305. FIG. 3B shows attaching the other side of the drape at 322 the open rear door of the automobile. This produces a changing space as shown in FIG. 3C with two doors open. FIG. 4 illustrates an alternative embodiment, with either only one door open, or on the two-door automobile. In FIG. 4A, the user attaches the suction cup to the front vehicle door 400, e.g. to the door window 402 or to the car door itself 404. The drape is then pulled around the door outside, and attached to the rear of the automobile, at so that the second side 410 of the drape attaches to the rear closed-door of the automobile e.g. the window or roof at 410. This produces a changing space inside as shown in FIG. 4C.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of forming a changing area and an automobile, comprising:
attaching a drape to a front door of an automobile using a removable attachment mechanism;
attaching a rear portion of the drape to the automobile, using the removable attachment mechanism,
where at least one of the front portion of the drape and the rear portion of the drape are attached to an open automobile door,
thereby forming an open space for changing area in a cavity formed by the open door and shielded by the drape.

2. The method as in claim 1, wherein the move movable attachment mechanism is a suction cup.

3. The method as in claim 1, wherein the drape is an opaque drape, with removable attachment mechanisms around a perimeter thereof, and where the perimeter includes a reinforced section.

4. A drape for forming a changing area using an automobile, comprising:
an opaque drape formed of a material;
the drape having an outer perimeter, where the outer perimeter includes a reinforced section therein, and includes a plurality of grommet holes in the reinforced section;
an attachment mechanism, which it's adapted for attachment to an automobile, at one end, and having a hook at the other end, the hook attaching to the grommet holes; and
where the outer perimeter of the drape is sized and shaped to fit between an open door of an automobile and to form a changing area therein.

5. The drape assembly as in claim 4, wherein the attachment mechanisms are suction cups.
